(19) United States
(12) Patent Application Publication
(10) Pub. No.: US 2004/0121803 A1
(43) Pub. Date: Jun. 24, 2004

(54) Transmission of audience monitoring data

(75) Inventors: Lee S. Weinblatt, Teaneck, NJ (US); Thomas Langer, Teaneck, NJ (US)

Correspondence Address: COHEN, PONTANI, LIEBERMAN & PAVANE, Suite 1210, 551 Fifth Avenue, New York, NY, 10176, US

(73) Assignee: Lee Weinblatt, Teaneck, NJ

(21) Appl. No.: 10/690,085

(22) Filed: Oct. 20, 2003

Related U.S. Application Data
(60) Provisional application No. 60/419,686, filed on Oct. 18, 2002.
(60) Provisional application No. 60/426,441, filed on Nov. 14, 2002.

(51) Int. Cl. H04L 12/66; H04Q 7/20

(52) U.S. Cl. 455/556.2; 455/445; 370/352; 455/460

(57) ABSTRACT

Monitoring an audience member tuned to a broadcast program. A portable audience monitoring unit is adapted to be worn by the audience member, and it detects a signal corresponding to the broadcast program to which the audience member is tuned. The detected signal is stored in the audience monitoring unit, and then the detected signal stored in the audience monitoring unit is outputted. The outputted detected signal is communicated to a central processing station by a communication means for transmitting the outputted detected signal with Cellular Digital Packet Data (CDPD) technology. In another embodiment, the communication means utilizes a ReFLEX protocol.

### RELATED APPLICATIONS

This application claims priority from U.S. Provisional Patent Application Serial No. 60/419,686 which was filed on Oct. 18, 2002 and from U.S. Provisional Patent Application Serial No. 60/426,441 which was filed on Nov. 14, 2002.

### FIELD OF THE INVENTION

This invention is directed to a technique for transmitting stored electronic data, that has been collected by a monitoring unit provided to each individual selected as an audience member, to a central processing station and, in particular, to the advantageous utilization of two-way wireless communication technology to enhance the value of such data by facilitating the speed with which such data can be obtained, processed and reported at the central processing station.

### BACKGROUND OF THE INVENTION

Various techniques have been developed for collecting information about what individuals are reading, listening to and viewing. Such individuals are collectively referred to herein as an “audience”, and each one is an “audience member.” The information (used interchangeably herein with “data”) is first stored for a designated period of time, and then it is sent to a central processing station where the data is analyzed so that meaningful information can be extracted from it. In its most basic form, the information is recorded in diaries kept by the audience, and the diaries are sent to the central processing station where the data is manually entered into a computerized database. In more modern approaches, the data is stored electronically in a monitoring unit, such as in a memory device. The entire monitoring unit, or just the memory device, is sent to the central processing station where the information is retrieved.

A preferred approach is to transmit the stored data electronically. Typically, this would be done over a public switchable telephone network (PSTN). Although such an approach is an improvement over the other approaches, it still has certain shortcomings. For example, if a portable device, such as a watch, is used to collect the information, at the end of the day it is set into a docking unit which is connected to a telephone line. The docking unit contains a modem, a recharger, as well as control circuitry to enable the data stored in the device to be transmitted to the central processing station, such as in response to an activation signal from the central processing station or at a pre-designated time.

The necessity for a docking station inconveniences the individual (i.e. the monitored audience member) because it has to be taken along when the individual travels away from home. Also, since it relies on the use of a telephone line, the user must always be next to or near a telephone outlet in anticipation of a data transfer session so the unit can be plugged into the telephone line. Furthermore, the data transfer session takes over a line while the data is being transmitted so that it is unavailable for any other use, such as a voice call. Anything that inconveniences an audience member is to be avoided because it tends to reduce use of the monitoring system and, therefore, adversely affects the amount of data collected. In addition, the data is transmitted (downloaded) to the central processing station typically only once per day, i.e. during the night, so as to minimize interference with use of the telephone line and to reduce telephone costs. Therefore, the information can be reported no sooner than a day after the monitored events have occurred.

Conventional wireless communication technologies were not suitable for the desired purpose. For example, paging and messaging services are wireless. However, such technology is one-way for transmitting data to the messaging unit, but not for receiving data from the messaging unit. Consequently, it is not suitable for the audience monitoring application of interest. Also, the widely installed cellular telephone technology, although it is designed for two-way voice communication, it has not been designed to communicate data efficiently in a cost effective manner.

### SUMMARY OF THE INVENTION

One object of the invention is to provide an improved technique for transmitting audience monitoring data from an audience monitoring unit to a central processing station.

Another object of the invention is to enable such data to be downloaded at a frequency considerably higher than once per day.

A further object of the present invention is to eliminate reliance on the use of a telephone land line for transmitting audience monitoring data from an audience monitoring unit to a central processing station.

Yet another object of the present invention is to eliminate reliance on a docking unit for the audience monitoring unit.

Still another object of the present invention is to enhance the convenience to the monitored audience members of transmitting audience monitoring data from an audience monitoring unit to a central processing station.

One other object of the invention is to provide improved power consumption and, thus, a longer battery life for transmitting audience monitoring data from an audience monitoring unit to a central processing station.

These and other objects are attained in accordance with one aspect of the present invention directed to an apparatus for monitoring an audience member tuned to a broadcast program, comprising a portable audience monitoring unit adapted to be worn by the audience member, wherein the unit includes means for detecting a signal corresponding to the broadcast program to which the audience member is tuned, and means for storing the detected signal. The apparatus further includes means for outputting the detected signal stored in the audience monitoring unit; and communication means for transmitting the outputted detected signal to a central processing station, wherein the communication means communicates with Cellular Digital Packet Data (CDPD).

Another aspect of the present invention is directed to a method for monitoring an audience member tuned to a broadcast program. A portable audience monitoring unit adapted to be worn by the audience member is provided. The portable audience monitoring unit detects a signal corresponding to the broadcast program to which the audience member is tuned. The detected signal is stored, and the detected signal stored in the audience monitoring unit is then outputted for transmission to a central processing station with communication means utilizing Cellular Digital Packet Data (CDPD) technology.

A further aspect of the present invention is directed to an apparatus for monitoring an audience member tuned to a broadcast program, comprising a portable audience monitoring unit adapted to be worn by the audience member, wherein the unit includes means for detecting a signal corresponding to the broadcast program to which the audience member is tuned, and means for storing the detected signal. The apparatus further includes means for outputting the detected signal stored in the audience monitoring unit; and communication means for transmitting the outputted detected signal to a central processing station, wherein the communication means communicates with a ReFLEX protocol.

Yet another aspect of the present invention is directed to a method for monitoring an audience member tuned to a broadcast program. A portable audience monitoring unit adapted to be worn by the audience member is provided. The portable audience monitoring unit detects a signal corresponding to the broadcast program to which the audience member is tuned. The detected signal is stored, and the detected signal stored in the audience monitoring unit is then outputted for transmission to a central processing station with communication means utilizing a ReFLEX protocol.

### BRIEF DESCRIPTION OF THE DRAWINGS

FIG. 1 is directed to a block diagram of a system arranged in accordance with the invention which utilizes CDPD technology.

FIG. 2 is directed to a block diagram of a system arranged in accordance with the invention which utilizes ReFLEX technology.

### DETAILED DESCRIPTION OF THE DRAWINGS

As will be explained below, one embodiment of the present invention applies Cellular Digital Packet Data (“CDPD”) technology to the task of transmitting stored electronic data, that has been collected in the course of monitoring one or more audience members, to a central processing station. Therefore, it is appropriate at this point to provide a brief explanation of this technology.

CDPD is a technique used for transmitting small chunks of data, commonly referred to as packets, over a cellular network in a reliable manner. It allows users to send and receive data from anywhere in the cellular coverage area at any time, quickly and efficiently. CDPD technology provides extensive, high speed (data can be sent at a rate of 19.2 kilobits per second), high capacity, cost effective data services to mobile users. With this technology, both voice and data can be transmitted over existing cellular channels.

CDPD enables both voice and data traffic on the same cellular channel. CDPD is an overlay to the existing cellular infrastructure and uses the same frequencies as cellular voice. Thus, CDPD works over the existing cellular networks but adds a few twists. In a conventional cellular call, the caller's modem connects to the nearest cellular antenna and stays connected to the network until he hangs up. The caller “owns” the connection from the moment the call is dialed until he hangs up, and the caller pays for connect time for every minute he is on the line. This scheme is known as a circuit-switched connection (also referred to herein as circuit switching). CDPD, on the other hand, is a packet-switched technology. That means that data is broadcast in packets rather than owning a particular frequency at a given time.

The CDPD overlay network is made up of a combination of the following key components that operate together to provide the overall service.

The Mobile End System (M-ES) which is defined as any mobile computing device which is equipped with a CDPD modem. Unlike voice cellular phones, the decision to initiate a transfer, or hand-off from one cell to another cell is under the control of the CDPD M-ES itself, as it is the M-ES which is responsible for monitoring the received signal strength of the cellular channels being used.

The Fixed End System (F-ES) which is defined as a stationary computing device.

The Mobile Data Intermediate System (MD-IS) which is a stationary network component with similar responsibilities to the cellular voice switch. It is responsible for keeping track of the M-ES's location and routing data packets to and from the CDPD network and M-ES appropriately. It has been referred to as the “brain” of the network, because of its functionality. Not only is it responsible for ensuring that an M-ES is valid to log on to the network, but it also stores information on the M-ES's last known location, traffic statistics and billing information. The Intermediate System (IS) is made up of off- the-shelf routers which are CDPD compatible, with the primary responsibility for relaying the data packets.

The Mobile Data Base Station (MDBS) is primarily responsible for RF channel management. It is located at the voice cell sites and is responsible for instructing the M-ES to “hop” to new channels for continued communication in the event voice communication (which is the priority traffic) is detected. It also handles the legwork for the M-ES in locating new channels when a hand-off is required between cell sites.

To effectively integrate voice and data traffic on the cellular system without degrading the level of service provided to the voice customer, the CDPD network implements a technique called channel hopping. The way this works is that when a CDPD mobile data unit desires to initiate data transmission, it will check for availability of a cellular channel. Once an available channel is located, the data link is established. As long as the assigned cellular channel is not needed for voice communications, the mobile data unit can continue to transmit data packet bursts on it. However, if a cellular voice customer initiates voice communication, it will take priority over the data transmission. At such time, the mobile data unit will be advised by the Mobile Data Base Station (which is the CDPD serving entity in the cell and constantly checks for potential voice communication on the channel) to “hop” to another available channel. In the event that there are no other available channels, then data transmission will be temporarily discontinued. It is important to note that these channel hops are completely transparent to the mobile data user. As far as the user can see, there is only one data stream being used to complete the entire transmission.

In 1992, a CDPD development consortium was formed with key industry leadership from several major telephone companies with the goal of creating a uniform standard for sending data over existing cellular telephone channels. They wanted to find a cost-effective, reliable, flexible, two-way wireless data communications service for mobile professionals which could compete with all digital voice and data services. To this end, in 1993, they published the Cellular Digital Packet Data System Specifications Release 1.0 guidelines which enabled modem and network providers to build compatible and competitive products which would function on/with the CDPD network. This publication is hereby incorporated by reference.

CDPD is not better than circuit switching for transmitting data, but rather it is different. They both have their place in the cellular wireless solution, and it may take the combination of both services to provide the customer with the optimal solution.

As stated above, the two technologies are different. CDPD is connectionless. It sends each packet intermittently, when there is “space” available. Circuit switching, on the other hand, sends the data over a continuous connection. For this reason, CDPD would be the optimal solution for a customer who is sending information which is both “short” and “bursty”, whereas the circuit switching solution would be optimal when sending a large data transmission. Another important difference is that CDPD uses less power than circuit switching. Sending packets of data only when necessary also helps conserve battery life, which is a precious commodity in many mobile scenarios. Since the information is sent in short bursts, the audience monitoring unit only has to be at high levels of power for short intervals. Additionally, CDPD has a “sleep” mode which allows the unit to conserve power when not in use, without logging off the network. Therefore, a mobile communications unit will have longer battery life using the CDPD technology rather than circuit switched connections. Moreover, CDPD uses an encryption technique to prevent an outside source from receiving the original data Costs for CDPD vary by provider, but are considerably lower than pricing plans for cellular phones. Packet switching is only part of the CDPD picture. Because CDPD is a data network, the modem does not get a phone number; it gets an Internet Protocol (“IP”) address. That means that the equipment at the phone company's office routes the user's CDPD traffic, in the form of IP packets, out to the Internet or to some other data network. In essence, the user is subscribing to a wireless Internet service provider.

CDPD also offers some signaling advantages over a simple analog connection. The CDPD device can recognize when a frequency is busy and delay transmission for a moment. Also, the receiving modem sends an acknowledgment of each packet so that the transmitter knows when to retransmit.

The CDPD approach has some other obvious advantages. Firstly, data can be transmitted frequently without interfering with use of a line for voice communication. The voice and data traffic can be handled together. Secondly, any network application that can use an IP network will work without modification in a CDPD network. Thus, it is relatively easy to implement data transmission without requiring special software.

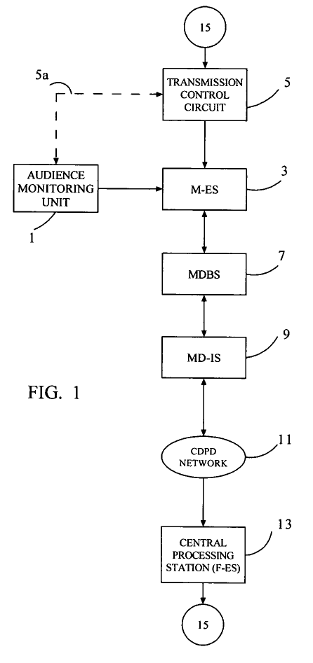

Let us now turn to FIG. 1. It depicts an audience monitoring unit 1. In the preferred embodiment, this is a portable unit, such as a watch or a fob, that is carried by the individual. It is provided with circuitry to detect signals corresponding to audio and/or video programs. The term “program” as used herein can be a commercial type (e.g. advertisement) and/or a non-commercial type (e.g. an entertainment show), and it involves a programming signal (e.g. a television signal) obtained from a program signal source (e.g. a television station), originated by a program provider (e.g. a television network, an advertiser, or a production company) and reproduced as audio and/or video. The “broadcast” of the program can be over the airwaves, cable, satellite, or any other signal transmission medium. The term “broadcast” also includes tape, CD-ROM, DVD and similar types of playback. An “audience” for such program reproduction is constituted of the persons who perceive the program. An example of a signal corresponding to audio and/or video programs that is detected by the audience monitoring unit 1 is a code signal which is combined for broadcast with the programming signal. The audience monitoring unit 1 detects the code signal within the broadcast signal of the program to which the audience member wearing the audience monitoring unit 1 is tuned.

The program is “performed” by any reproduction equipment which results in some form that is perceptible to human beings, the most common being video and audio. The “reproduction equipment” is any and all types of units to convert a broadcast signal into human perceptible form.

The audience can be described as being “tuned” to a specific program signal source, such as a television (“TV”) or radio broadcast station. The word “tuned” is applied herein to all situations in which a person chooses to be an audience member of a program or programs being broadcast by that specific program signal source, such as by twisting a dial or operating a remote control device of a TV, for example, in order to set that TV so it can receive and perform the programs from that source. For purposes of convenience, the discussion presented below will involve TV, and the members of the audience will be referred to as viewers.

Audience monitoring unit 1 includes circuitry to detect, process and store signals indicative of what program the viewer is tuned to. An example of such a unit can be found in U.S. Pat. Nos. 4,718,106, 5,457,807 and 5,630,203.

Coupled to unit 1 is M-ES device 3 (see above) which includes a CDPD modem. Device 3 will transmit the monitoring data stored in unit 1 in accordance with an actuating output signal generated by transmission control circuit 5. Circuit 5 is essentially a timing circuit that is set to actuate data transmission at preset intervals. The frequency with which such downloads occur depends on the selected interval. This can be, for example, once per hour or even once per minute. The selection is made based on the nature of the monitored programs and the use to which the data is being put. Thus, if the program is a commercial, there may be little value to transmitting the stored data to the central processing station frequently, e.g. even once per day may be sufficient. However, if the program is a breaking news event, it is important to know on a minute-by-minute basis whether the news event is holding the audience's attention. If it is, then intense coverage should be continued. However, if the audience is losing interest, then a return to regular programming would be preferable.

Circuit 5, rather than being a time-controlled component, could be a data-content-controlled component. In particular, circuit 5 could check the amount and/or type of data stored in unit 1. This is represented by broken line 5a. Thus, circuit 5 could actuate a download when a threshold amount of data is stored. Likewise, a download could be actuated immediately when certain data is detected. Of course, circuit 5 could also be designed to respond to a trigger signal 15 from the central processing station 13.

MDBS unit 7 performs the above-described functions in the passage of signals to the stationary network component 9 (see discussion of MD-IS above). The signals from MD-IS 9 are handled by CDPD network 11 which passes them to the central processing station 13 (see discussion of F-ES above).

It is believed that since the design of elements 3, 7, 9, 11 and 13 is conventional, no details thereof are deemed necessary. Likewise, the design of circuit 5 would be readily apparent to anyone with ordinary skill in the art and, therefore, its details are also deemed to be unnecessary.

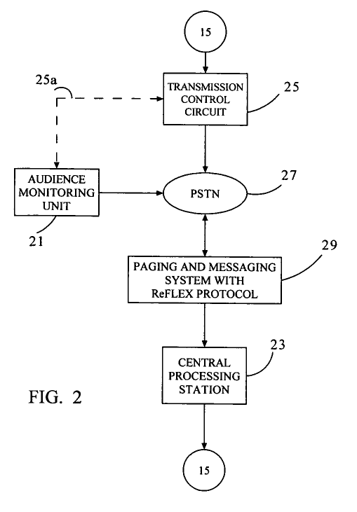

A second embodiment of the invention is shown in FIG. 2. By way of background, Motorola created a wireless communication protocol called FLEX which is aimed at enhancing the channel efficiency and reducing the cost of traditional paging systems while enabling new products and value-added services. The FLEX protocol is a multi-speed, high-performance paging protocol adopted by leading service providers worldwide. It is generally regarded as the global de facto standard for high-speed paging. ReFLEX is an enhancement of FLEX in that it enables true two-way paging and messaging by adding a response channel. This protocol enables the system to guarantee delivery of a message and, if the device supports it, allows a user to reply instantly to a page directly from the messaging unit.

It may be helpful to review at this point some salient aspects of a paging system, the FLEX protocol and the ReFLEX protocol.

The primary elements of a paging system are the input source (most often a telephone), the public switched telephone network (PSTN), one or more paging terminals and transmitter equipment, as well as the messaging unit (a pager). A paging system is typically operated by a service provider or “carrier” who incurs the cost of building and operating the system. Each service provider licenses a spectrum from the authorized government body, i.e. the Federal Communications Commission (FCC) in the United States, to operate a paging frequency, or channel, within a regulated geographical area which is either local, regional or national in scope.

The input source can be a personal computer, telephone, desktop entry device or an operator dispatch where someone is paid to take and enter a message.

Pages are sent out over a local phone system, referred to as the public switched telephone network (PSTN), which is owned and operated in the United States by Regional Bell Operating Companies, or RBOCs. In many countries of the world, the Postal Telephone and Telegraph (PTT) still operates both local and long distance telephony. The PSTN provider owns the “local loop,” which is typically a twisted pair of copper wires, and provides connectivity from the input source (telephone, fax machine, computer, customer owned PBX) to a PSTN-owned Central Office Switch.

Paging terminals and transmitter equipment, or radio frequency (RF) link systems, may be owned and operated by large institutions, e.g. hospitals, fire departments, state and local governments, for their internal operations, but more typically are provided by paging service providers who incur the cost of building and operating a paging system for organizations that do not want to invest in this type of equipment. The paging terminal serves as an interface to the public switched telephone network, or to a private switch (PBX) if public access is not required. The paging terminal, like private telephone switches, cellular switches, voice messaging systems, etc., are viewed by the PSTN as “just another switch,” and are connected to one or more switches in the PSTN through one or more trunk circuits. The paging terminal is responsible for receiving, processing, storing and forwarding information from the caller. The paging terminal validates the type of call, determines the authenticity of the subscriber and serves as the interface to the RF network or to other paging terminals within a multi-city paging network. The RF network, often comprised of several transmitters, accepts the data from the paging terminal via telephone lines, RF link or satellite, and decodes the data streams containing the paging data. Upon decoding the data, the transmitter translates the paging data into signals that modulate the RF paging signal at the desired transmit frequency.

Pagers can be leased from a paging service provider or purchased through various retailers. There are several ways a pager can receive a message including: tone only—the pager alerts only; numeric—the pager alerts the subscriber that he or she has received a message and a phone number appears on the pager (requires a touch tone phone—rotary phones will not work); alphanumeric—text and numbers appear on the pager either in real time or retrieved from memory like an answering machine; and voice—the message is heard audibly from the pager. The subscriber can often select the method in which he or she is alerted, whether it is through visual stimuli (an icon or LED flashes), audible stimuli (a standard alert is a beep, a pleasing alert can be a chime or sequence of musical notes) or silent stimuli (vibrate mode).

How does a paging system work? A sender uses one of the above-mentioned input sources to send the message or page through the local phone system, or PSTN. The PSTN “switches” the page to a carrier paging terminal Once the paging terminal receives the page, it processes, stores and forwards information from the caller. Additionally, it encodes the page for transmission through the carrier paging system.

Typically, an encoder accepts the incoming page, validates the pager address and “encodes” the address and page into the appropriate paging signaling protocol. Once the page is encoded, it is sent to the RF link system which includes the link transmitter and link receiver. The link transmitter sends the page to the link receiver, which is located at the various paging transmitter sites along the channel. The transmitter then broadcasts the page across the coverage area on the specified carrier frequency.

At the root of all paging systems is the paging signaling protocol. A paging protocol is like a body's nervous system, controlling the messages sent to the brain which enables “thinking.” A protocol is a type of language, or set of rules, that allows information to flow over a telephone network through the airwaves and connect with a pager. These rules dictate capacity, latency and signaling speed, pager battery life and data integrity, all critical qualities in the eyes of the service provider and end user.

How does FLEX protocol-based technology work? Once data is received from the encoder, FLEX technology organizes the message into frames of data or a specific sized packet containing bits of data. There are a total of 128 frames in a FLEX protocol system numbered zero through 127. It takes exactly four minutes to transmit all 128 frames regardless of the FLEX protocol speed. The transmission of all 128 frames is called a FLEX cycle. Since one cycle has a duration of four minutes, 15 cycles can be transmitted in one hour.

The FLEX protocol code maximizes channel capacity and speed, the pager's battery life and data integrity, all key ingredients for a service provider evaluating a paging protocol. The FLEX protocol runs at three different speeds allowing service providers a choice in matching the potential capacity of a FLEX protocol-based paging system to their individual requirements. A fast protocol signaling speed allows lower latency for potential messaging as well as increased subscribers per channel.

Aside from the higher speeds, on a FLEX protocol-based system a pager can operate at any of the assigned channel speeds, eliminating the need to stock separate pagers for each signaling speed used in the system. Effectively, “one pager does it all” with the FLEX protocol-based pagers.

The FLEX protocol is a “synchronous” time slot protocol designed to increase the battery life of pagers. This is a key benefit for the end user. FLEX protocol-based technology extends battery life by minimizing the pager's power consumption. Instead of sending out messages at random, all paging data intended for a particular pager is scheduled into a pre-defined time slot. This allows a FLEX protocol pager to selectively decode one or more frames over each four minute FLEX cycle, so that the pager does not need to waste its battery life decoding data intended for other pagers. Depending on the subscriber's message latency preference, this active frame position can be as often as every frame, a select number of frames or as seldom as once per each FLEX cycle. This significantly reduces the power a pager requires to operate which in turn improves battery life and permits smaller batteries and, therefore, smaller designed pager units.

FLEX technology provides accurate message delivery by offering protection from fading conditions, such as bridges or overpasses. It provides 12 times the fading protection of the POCSAG 1200 protocol and 24 times the fading protection of POCSAG 2400 protocol.

The ReFLEX protocol enables true two-way paging and messaging by adding a response channel. This protocol enables the system to guarantee delivery of a message and, if the device supports it, allows a user to reply instantly to a page directly from the messaging unit. This protocol is licensed by Motorola to service providers and its details are known and readily applied by anyone with ordinary skill in the art. Accordingly, it is not deemed necessary to provide such details thereof herein.

Turning now to FIG. 2, audience monitoring unit 21, central processing station 23, and transmission control circuit 25 are respectively similar to audience monitoring unit 1, central processing station 13, and transmission control circuit 5 of FIG. 1.

The audience monitoring data stored in audience monitoring unit 21 is retrieved and outputted (by a circuit which can be a part of the unit) in the form of a message or page through the local phone system, or PSTN 27. The PSTN 27 “switches” the page to a carrier paging terminal which includes paging and messaging system 29 which implements the ReFLEX protocol. Once the system 29 receives the page, it processes, stores and forwards the information to central processing station 23 in the manner described above.

In accordance with the invention, the ReFLEX protocol is utilized for its ability to use the audience monitoring unit 21 as a transmitting device for communicating the stored data to the central processing station. Thus, the invention includes the required circuitry in the audience monitoring unit 21 assigned to each of the audience members which is required to retrieve and transmit the stored data under the ReFLEX protocol. Such circuitry is, of course, compatible with the overall paging system, as described above, which implements the ReFLEX protocol. It is not deemed necessary to provide details of such circuitry because this is well within the knowledge and capability of anyone with ordinary skill in the art.

As should be readily apparent, the adoption of two-way wireless data communication, such as from cellular telephone-related technology (e.g. CDPD) and paging and messaging technology (e.g. ReFLEX), as described above, to the field of audience monitoring and, in particular to the downloading of information from a monitoring device to the central processing station, results in several significant advantages. Of particular importance is the added convenience to the monitored audience member who no longer has to bother with a docking station in terms of plugging it into a wall telephone outlet, remembering to set the monitoring unit into it, and bringing it along on trips. Also, the monitoring unit need not be recharged because it uses less power with CDPD technology. Additionally, the monitoring unit requires less memory to store data because the memory can be emptied at more frequent intervals. Moreover, the availability of data to be transmitted to the central processing station at significantly more frequent intervals makes it possible to obtain and analyze data about the audience practically as events occur.

Although a description of the preferred embodiment of the present invention has been provided in detail above, various modifications thereto will be readily apparent to anyone with ordinary skill in the art. For example, the stored data could be obtained from monitoring the readership of publications as disclosed in U.S. Pat. Nos. 4,781,596 and 5,019,679. These and other such modifications are all intended to fall within the scope of the present invention.

We claim:

1. Apparatus for monitoring an audience member tuned to a broadcast program, comprising:
a portable audience monitoring unit adapted to be worn by the audience member, and including:
(a) means for detecting a signal corresponding to the broadcast program to which the audience member is tuned, and
(b) means for storing the detected signal;
means for outputting the detected signal stored in said audience monitoring unit; and
communication means for transmitting the outputted detected signal to a central processing station, wherein said communication means communicates with Cellular Digital Packet Data (CDPD).

2. A method for monitoring an audience member tuned to a broadcast program, comprising:
providing a portable audience monitoring unit adapted to be worn by the audience member;
detecting with said portable audience monitoring unit a signal corresponding to the broadcast program to which the audience member is tuned;
storing the detected signal;
outputting the detected signal stored in said audience monitoring unit; and
transmitting the outputted detected signal to a central processing station with communication means utilizing Cellular Digital Packet Data (CDPD) technology.

3. Apparatus for monitoring an audience member tuned to a broadcast program, comprising:
a portable audience monitoring unit adapted to be worn by the audience member, and including:
(a) means for detecting a signal corresponding to the broadcast program to which the audience member is tuned, and
(b) means for storing the detected signal;
means for outputting the detected signal stored in said audience monitoring unit; and
communication means for transmitting the outputted detected signal to a central processing station, wherein said communication means communicates with a ReFLEX protocol.

4. A method for monitoring an audience member tuned to a broadcast program, comprising:
providing a portable audience monitoring unit adapted to be worn by the audience member;
detecting with said portable audience monitoring unit a signal corresponding to the broadcast program to which the audience member is tuned;
storing the detected signal;
outputting the detected signal stored in said audience monitoring unit; and
transmitting the outputted detected signal to a central processing station with communication means utilizing a ReFLEX protocol.
